(19) United States
(12) Patent Application Publication
(10) Pub. No.: US 2020/0139558 A1
(43) Pub. Date: May 7, 2020

(54) GRIPPER SYSTEM FOR A ROBOT

(71) Applicant: Zhongrui Funing Robotics (Shenyang) Co. Ltd., Shenyang (CN)

(72) Inventors: Hung VU, Zürich (CH); Hayato OMORI, Zürich (CH); David TRÜSSEL, Zürich (CH); Lukas WIRTH, Winterthur (CH)

(21) Appl. No.: 16/620,672

(22) PCT Filed: Oct. 6, 2017
(86) PCT No.: PCT/EP2017/075577

§ 371 Date: Dec. 9, 2019

Related U.S. Application Data
(60) Provisional application No. 62/521,686, filed on Jun. 19, 2017.

(51) Int. Cl. B25J 15/00; B25J 13/08; B25J 11/00

(52) U.S. Cl. CPC B25J 15/0014; B25J 15/0028; B25J 13/082; B25J 15/0033; B25J 11/008; B25J 13/085; B25J 13/086

(57) ABSTRACT

A gripper system for a robot includes a first gripper element for carrying an object. The first gripper element includes a gripper hand with a support plane for supporting the object and a gripper thumb opposing the support plane. The first gripper element also includes a slot between the gripper hand and the gripper thumb for allocating at least part of the object to passively secure the object from tilting. This gripper system is advantageous when moving around carrying an object such as a tray or plate on which articles are loosely positioned.

### FIELD OF THE INVENTION

The invention relates to a gripper system for a robot comprising a gripper element for carrying an object, and a robot comprising such a gripper system. Gripper systems of these kinds are used in personal care robots for humans.

### BACKGROUND OF THE INVENTION

Gripping tools for robot systems have long been known in the prior art in many different variants. The known gripping tools usually comprise two gripper fingers, each with one gripper jaw each of which having one gripper tip. The gripper jaws can, for example, be fastened movably to linear guides and they can be constructed movably towards and away from each other. As a result, also the two gripper jaws attached thereto can be moved exactly towards and away from each other in such a manner that objects can specifically be grasped, moved to another place and put down again. Such gripper systems are known to the man skilled in the art under the term “parallel-grippers”. Such systems for grasping workpieces are for example known from EP02231B1, EP0993916B1 or EP2548706A1.

There are robots, so called “buckling arm robots” described for example in WO02/086637A1″ whose application is much more flexible and which are often used advantageously in particular for mobile robot systems.

Nowadays gripper fingers are often not only mechanical gripping tools, but highly complex systems containing electronic components and sensors of different types, such as optical cameras, ultrasonic sensors or other acoustic sensors, such as microphones, or thermal sensors, force sensors etc. By means of such sensors a correspondent robot system can “feel” its environment with the gripper fingers or detect the properties of its environment which are essential for the function of the robot system.

Thus, such robot system can for example recognize independently whether an object to be grasped is rather a soft object, such as a plastic bottle, or rather a hard object, such as a glass bottle and it can then adjust independently and flexibly a force necessary for the gripper fingers to grasp the object to an optimum value. Depending on the existing sensors the robot system can also recognize the type of object or it can, for example, distinguish whether the object to be grasped is a dead object or a living object. Nowadays such robot systems can recognize and analyse a plurality of other properties. In particular, even intelligent robot systems are known which can learn independently from the environmental data recorded by sensors and, as a consequence, they can, for example, adapt to the requirements of initially unknown environments or initially unknown objects to be grasped.

This is of particular importance if such a robot system is used for carrying out delicate assemblies with very different components, or if, for example, a human being should be supported in various everyday activities. In case such a robot system interacts directly with a human being, a highly sensitive sensor technology is, of course, of the utmost importance for the simple reason of security.

Particular importance is attached to the gripper tip of a gripper finger because on the one hand for grasping an object to be moved the gripper tip must be brought in touching contact with this object and on the other hand the gripper tip often contains the sensors necessary for recognizing the environment and recognizing the properties of the objects to be grasped. For this reason, in many applications the gripper tip must in each case be individually adjusted to the tasks to be performed specifically and the properties of the working environment, respectively, and thus finally to the particular properties of the objects to be grasped and to be moved.

In order to use one and the same robot system for a plurality of different tasks, it is a known method to design the gripper tips exchangeable. For example, a set of different gripper tips can be provided which can differ, for example, in their gripping geometry, material, surface finish, sensor technology, and so on, each being optimally adapted to certain tasks to be performed. Thus, very different tasks can be carried out by one and the same robot system only by replacing the gripper tips of the gripper finger.

One such a task, in case a robot is interacting with humans, especially elderly people, may be to offer articles such as a glass of water or medicines. As a personal butler, the robot may offer such articles by carrying them on an object, such as tray or plate. As the articles are usually loosely placed on the tray, it is a particular technical challenge to have the robot interact with the object in such a way that the articles remain stable on the tray even while moving around.

### SUMMARY OF THE INVENTION

The invention has as an objective providing a gripper system of the kind set forth, which enables a robot to move about while holding a tray supporting loosely placed articles. This object is achieved with the gripper system according to a first aspect of the invention as defined in claim 1.

A gripper system for a robot, comprising a first gripper element for carrying an object, wherein the first gripper element comprises a gripper hand with a support plane for supporting the object, a gripper thumb opposing the support plane, and a slot between the gripper hand and the gripper thumb for allocating part of the object. The invention thus provides a gripper system in which the gripper hand and gripper thumb are designed to passively secure the object—including any articles it carries from tilting and falling on a ground or floor. Passively here means that there is no need for any external power supplied to the system in order to prevent the object from falling after a single gripper element has been positioned appropriately relative to the object. As the object extends beyond the gripper hand, gravity creates a moment relative to the tip of the gripper hand. Advantageously, the thumb functions as a lock for preventing the rim of the object inside the slot from tilting upward and thus for preventing the object, including the articles it carries, falling from the support plane of the gripper hand. In contrast prior art gripper systems teach providing a first and second finger to actively squeeze an object between the fingers, thus teaching supplying power to the system for keeping the fingers appropriately squeezed after grabbing the object.

In an embodiment, the gripper hand and/or gripper thumb comprise a sensor arranged to provide a first control signal. Advantageously, the control signal may be used for orientation purposes of the first gripper element relative to the object and or for controlling the engagement force of a second gripper element in order to secure the object between the first and second gripper elements.

According to an embodiment of the invention the sensor comprises a photoelectric emitter and receiver combination and the first control signal is indicative of the presence of the object. Advantageously, the sensor allows for creating a control signal to determine whether a tray is positioned correctly in the slot. The control signal, thus provides feedback to a control system of the robot for reorienting the gripper system.

In another embodiment, the sensor comprises a force sensor and the first control signal is indicative of a load of the object. Advantageously, the force sensor detects the pressure a tray, including the articles it supports, exercises on it due to the minimal tilting of the tray inside the slot. A larger load control signal may be use by the robot control system to appropriately engage a second gripper element with a larger force towards a top side of the tray for securing it between the first and second gripper elements.

In yet another embodiment, the gripper system further comprising a second gripper element cooperating with the first gripper element for securing the object between the first and second gripper elements. Advantageously, the second gripper element may improve securing the object.

In an embodiment, the second gripper element comprises two gripper fingers spaced apart for securing the object. In an embodiment, the gripper thumb of the first gripper element comprises a prong for engaging between the spaced gripper fingers. Advantageously, the spaced apart fingers cooperate with a prong extending from the gripper thumb and sized to be congruential with the spaced apart fingers. Advantageously, engaging the fingers and prong improves prevention of the object to be tilted sideways, i.e. prevent tilting around a length axis of the gripper system.

In an embodiment, the gripper fingers each comprise a fingertip comprising a force sensor for providing a second control signal. Advantageously, the second control signal allows for determining whether the object is grabbed stably. A stable grasping condition may only be satisfied when the forces detected by the sensors are above a predetermined minimal value. In an embodiment, the control signal is indicative of a difference between the forces detected in respective gripper fingers. Advantageously, a (dynamic) difference in the forces detected by the sensors in the respective fingers provides information on the sideways stability of the tray. Especially under circumstances where the robot moves from one location to another while carrying articles on top of a tray, such a differential control signal may provide feedback for the secure operation of carrying the tray and stable position of the articles supported.

In yet another embodiment, the first and second gripper elements comprise external surfaces comprising force sensors for collision detection with an article. Advantageously, this the force sensors in external surfaces provide a control signal allowing the robot to correct and steer away, thus avoiding the collision event.

According to another aspect, the invention provides a robot system, in particular an industrial robot or a service robot for supporting humans comprising a gripper system according to the first aspect of the invention.

In an embodiment, the robot system further comprises a control system arranged to controllably operate a driver to engage first gripper element with second gripper element for securing object between the elements. In an embodiment a control signal input of control system is based on a first and/or second control signal provided by sensors in the first respectively the second gripper element.

These and other aspects of the invention will be apparent from and elucidated with reference to the embodiments described hereinafter. Appreciate, however, that these embodiments may not be construed as limiting the scope of protection for the invention. They may be employed individually as well as in combination.

### BRIEF DESCRIPTION OF THE DRAWINGS

Further details, features and advantages of the invention are disclosed in the following description of exemplary and preferred embodiments in connection with the drawings.

FIGS. 1A&B schematically show an illustration of a robot carrying a tray and plate using a gripper system according to the invention.

FIGS. 2A&B show diagrammatically an embodiment of a first and second gripper element of a gripper system according to the invention.

FIGS. 3A&B show a side view and front view of an embodiment of the first gripper element according to the invention.

FIG. 4 shows a perspective illustration of an embodiment of the second gripper element according to the invention

FIG. 5 shows a control system of the robot for controlling the gripper system according to the invention.

FIG. 6 shows another embodiment of the gripper system.

Those skilled in the art will appreciate that elements in the drawings are illustrated for simplicity and clarity and have not necessarily been drawn to scale. For example, the dimensions of some of the elements in the drawings may be exaggerated relative to other elements to help improve understanding of the various embodiments of the invention. Furthermore, the terms “first”, “second”, and the like herein, if any, are used inter alia for distinguishing between similar elements and not necessarily for describing a sequential or chronological order. Moreover, the terms “front”, “back”, “top”, “bottom”, “up”, “down”, “over”, “under”, “proximal”, “distal”, and the like in the description and/or in the claims, if any, are generally employed for descriptive purposes and not necessarily for comprehensively describing exclusive relative position. Also, the term “engagement feature” may also constitute a “disengagement feature”. Skilled artisans will therefore understand that any of the preceding terms so used may be interchanged under appropriate circumstances such that various embodiments of the invention described herein, for example, are capable of operation in other configurations and/or orientations than those explicitly illustrated or otherwise described.

### DETAILED DESCRIPTION OF THE EMBODIMENTS

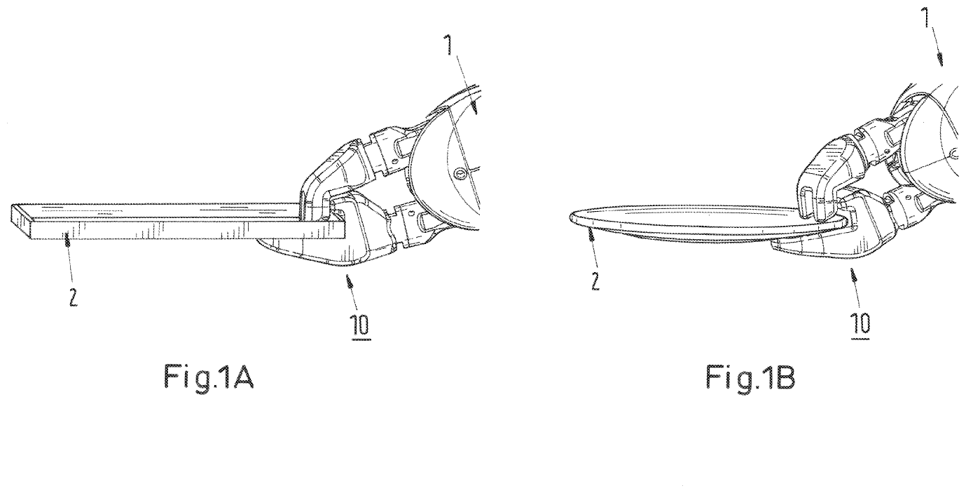

FIG. 1 shows a robot 1 comprising an arm comprising a gripper system 10 at its distal end. In a typical use case, service robot 1 performs personal care duties, such as typically butler tasks, to the benefit of humans, such as elderly citizens. One such task is offering humans articles (not indicated) for consumptions, for example drinks, food, medicine, or articles for use, for example a pen, a postcard, a game, and the like. These articles may be offered on top of a tray or plate 2. Usually these articles will be positioned loosely on the tray for allowing the person to collect them at his own convenience. Especially when robot 1 gathers the articles at a remote location, it will need to move towards the person for servicing them. As robot 1 moves towards the person its gripper system 10 may securely hold tray 2 in such a way that the articles remain stable on top of the tray even while moving around.

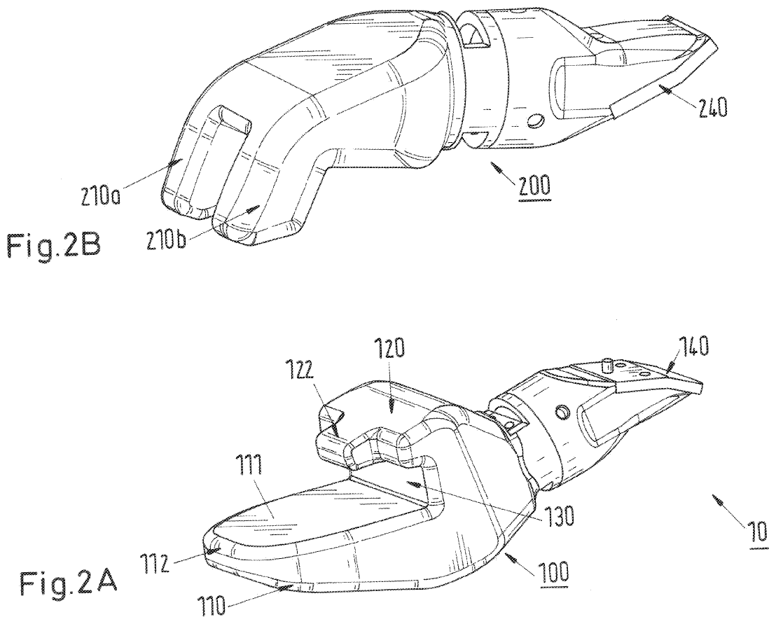

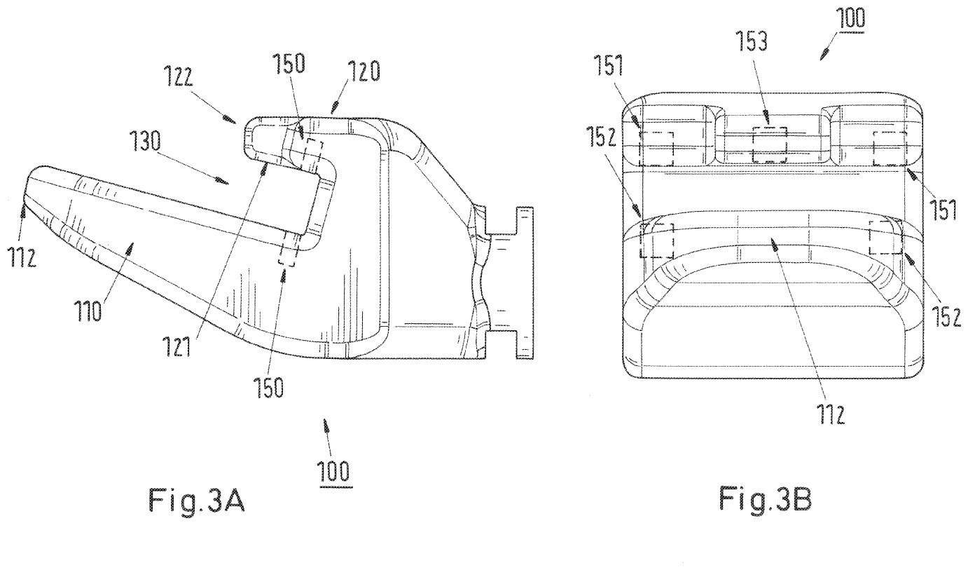

To this end, as shown in FIGS. 2A, 3A, and 3B, gripper system 10 comprises a first gripper element 100. Typically, first gripper element comprises a gripper hand 110 providing a support plane 111 for supporting an object 2, such as the tray or plate. As object 2 will under practical circumstances extend beyond support surface 111, the later supports former only near its side or rim. To prevent object 2 from tilting around a tip 112 of gripper hand 110, especially when articles are positioned on top, first gripper element 100 further comprises a gripper thumb 120 positioned such that it opposes support plane 111. Gripper thumb 120 is designed to passively secure object 2 from tilting, i.e. without a need for external power. To this end, gripper thumb 120 extends over support plane 111 such that a slot 130 is created between thumb and plane. Slot 130 has a width and depth appropriate for accommodating at least a part of object 2. When object 2 is inserted, or conversely, when robot 1 operates to position its gripper system 10 to grab object 2, at least a side or rim will enter slot 130 to an extend that when first gripper element 100 is lifted, object 2 will be blocked from tilting by a bottom surface 121 of gripper thumb 120 facing support plane 111.

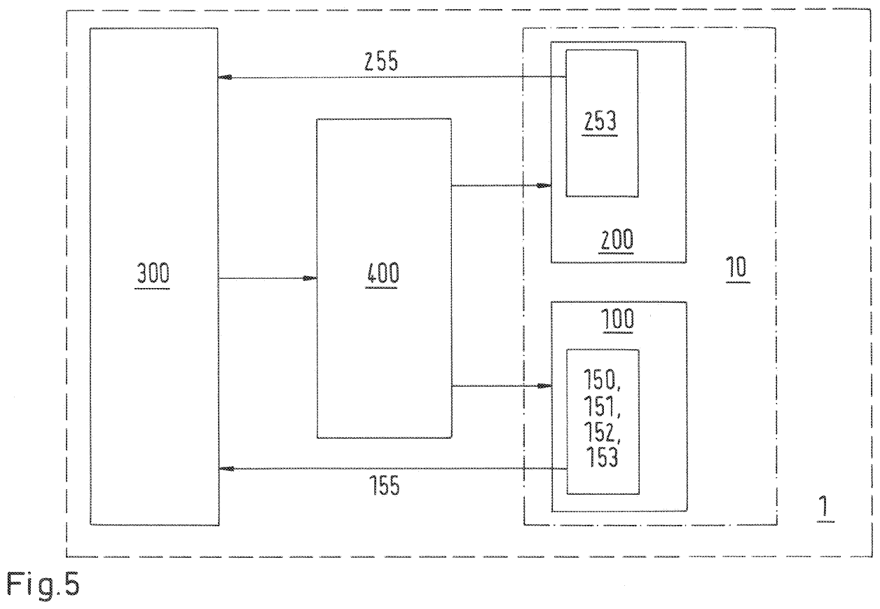

In order to determine if first gripper element 100 is positioned appropriately relative to object 2, first gripper element may comprise a first sensor 150. In an embodiment, sensor 150 comprises a photoelectric emitter 151 and receiver 152 combination, such as a (infrared) light emitting diode and photo diode. Emitter 151 may be positioned within slot 130 near the bottom surface 121 of gripper thumb 120, while receiver 153 may be positioned opposite of emitter 151 near support plane 111. When object 2 is inserted into slot 130 it will interrupt light transmitted from emitter 151 to receiver 152, thus a control signal 155 may indicate that object 2 is positioned with appropriate depth inside slot 130. Until control signal 155 provides the appropriate feedback, robot 1 may reposition gripper system 100 relative to object 2 through control system 300 and driver 400—see FIG. 5. In another embodiment, sensor 150 may comprise a force sensor 153 positioned near a bottom surface 121 of gripper thumb 120 for detecting a force with which object 2 presses against it. In this case a control signal 155 may be generated by force sensor 153, a static part of which is indicative of the load of the tray, including any articles on top of it. A dynamic part of control signal 155 may provide information on the stability of the tray once grasped by gripper system 10, especially under circumstances where robot 1 moves around while carrying tray 2. In yet another embodiment, first gripper element 100 comprises both the force sensor 153 and the photoelectric emitter 151 and receiver 152 combination.

Finally, gripper thumb 120 may comprise a prong 122 extending from it for reasons to be discussed below. Preferably, prong 122 extends outwardly parallel to support plane 111.

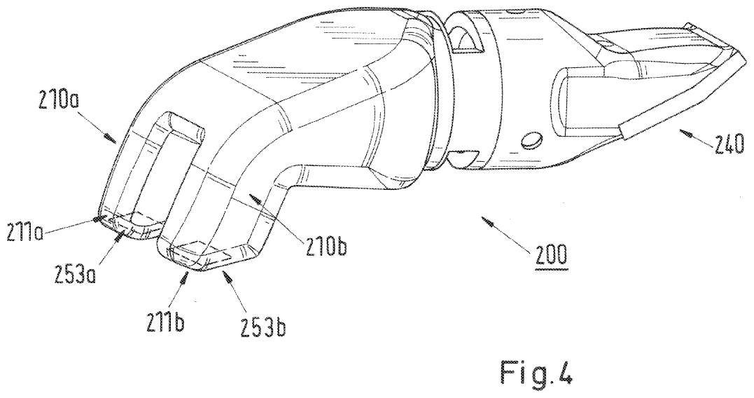

Returning now to FIGS. 2B and 4, gripper system 10 may comprise a second gripper element 200, positioned relative to the first gripper element 100 such that it allows cooperation with the first gripper element for securing the object between the first and second gripper elements. Advantageously, the second gripper element 200 improves stable operation of carrying tray 2 by robot 1, especially under automotive movement of the robot. Circumstances “en route”, such as crossing a doorstep or any other unevenness, may result in dynamic behaviour of tray 2 of such a magnitude that stable operation is not secured. To prevent articles carried on tray 2 to fall or spill over, second gripper element 200 may provide additional stability by engaging with a top side of object 2 when a bottom side of object w is supported by support plane 111 of first gripper element 100. To this end, second gripper element 200 may comprise two gripper fingers 210a,b extending along a length axis of the second gripper element. Advantageously, gripper fingers 210a,b are spaced apart in a direction perpendicular to the length axis, i.e. in a width direction of gripper system 10. Prong 122 and the spaced apart finger 210a,b may be congruentially dimensioned so that the fingers and prong cooperate upon engaging second gripper element 200 towards first gripper element 100 in order to prevent tray 2 to tilt around the length axis of gripper system 10. Thus in a closed grasping position of second gripper element 200, prong 122 tightly fits in between the gripper fingers 210a,b so that a single locking surface is created preventing tray 2 from rotating around the length axis.

In an embodiment, at least one of the gripper fingers 210a,b, and preferably both fingers, comprise a sensor 253. Advantageously, a second control signal 255 generated by sensor 253 allows for determining whether the object is stably grabbed. A stable grasping condition may only be satisfied when the forces detected by the sensor(s) are above a predetermined minimal value.

Below such a minimal value, a control system 300—see FIG. 5—of robot 1 may control a diver 400 for repositioning the gripper elements 100,200 relative to each other or gripper system 10 relative to object 2.

In an embodiment, both gripper fingers 210a,b comprise sensors 253a,b and they are arranged to provide a control signal 255 indicative of a difference between the forces detected by the respective gripper fingers.

Advantageously, a (dynamic) difference in the forces detected by the sensors 253a,b in the respective fingers provides information on the sideways stability of the tray. Especially under circumstances where the robot moves from one location to another while carrying articles on top of a tray, such a differential control signal may provide feedback for the secure operation of carrying the tray and stable position of the articles supported. Again, control system 300 may operate gripper system 10 through driver 400 to improve engagement of the first 100 and second 200 gripper elements and thus stabilise carrying plate 2. Alternatively, control system 300 may influence the linear or rotational velocity of the robot in order to stabilise the articles carried on tray 2.

While gripper system 10 may be physically sized to appropriate dimensions for performing a specific task, in case of butler duties such as carrying a tray the length of gripper hand 110 is in the 5 to 15 cm range, such as 7 cm. Then, the gripper hand width typically is in the 4 to 12 cm range, such as 6 cm. Slot 130 may be chosen appropriately to fit the height of the object to be carried. In case of a tray a 1 to 2 cm slot width is suitable. Gripper thumb 120 may extend from the base of first gripper element 110 over and above gripper hand 110 such that the depth of slot 130 is in the 1 to 5 cm range, such as 2 cm. The overall length of first gripper element 100 from its base to a tip of gripper hand 110 thus typically is around 12 cm. The overall thickness of first gripper element 100 from a bottom/back side of gripper hand 110 to a top side of gripper thumb 120 results from the design considerations of the size of object 2 to be carried, but for a tray typically is around 5 to 7 cm. The dimension of second gripper element 200 is commensurate with that of first gripper element 100. For example, its overall length may be around 8 cm, and its overall width 6 cm. Gripper fingers 210 may be spaced apart 1 to 2 cm, while prong 122 of gripper thumb 120 may be sized to be congruential with the spaced apart fingers. Gripper fingers 210 may comprise a bend such that the distal part of the fingers is angled, such as between 110° and 120°, relative to a length axis of second gripper element 200. Advantageously, this allows for improving securing object 2 between the first and second gripper elements. Similarly, support plane 111 of first gripper element 100 max be angled, such as between 10° and 30°, relative to a length axis of the first gripper element. Advantageously, this allows for appropriately orienting the gripper element relative to an object surface of the object 2 to be grabbed.

In embodiments, the bases of first 100 and second 200 gripper elements may be connected to respective connecting elements 140, 240—see FIG. 2—for enabling exchangeably connecting the gripper system to a distal arm end of robot 1.

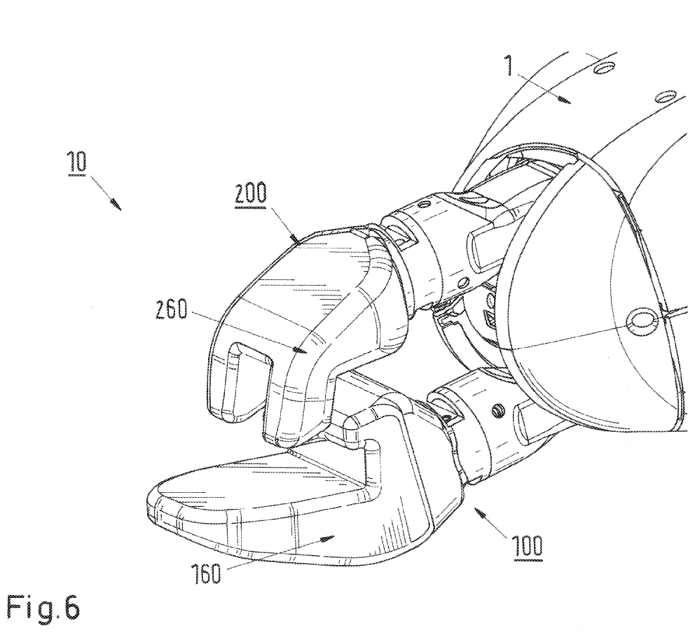

First 100 and second 200 gripper elements may comprise a constructive core surrounded by a soft lining. As an example, the core may comprise a hard ABS plastic enabling accommodation of the tension and stress upon carrying object 2. Furthermore, the core may allocate electrical connections to sensors 150,250. As a further example, the soft lining may comprise a polyurethane shore, accommodating preferred haptic properties for human-machine interaction. In order to accommodate safe interaction with objects and humans, outer edges of first (100) and second (200) gripper elements may be rounded. Furthermore, the soft lining on external surfaces of gripper system 10, such as bottom and side surface 160 of first gripper element 100 and top and side 260 of second gripper element 200—see FIG. 6—may comprise flexible force sensors arranged to provide a control signal indicative of a collision event with objects or humans. As a result, control system 300 of robot 1 may, based on the control signal, steer gripper system 10 in such a direction to avoid the collision event.

Although the invention has been elucidated with reference to the embodiments described above, it will be evident that alternative embodiments may be used to achieve the same objective. The scope of the invention is therefore not limited to the embodiments described above.

As an example, sensor 150 may comprise a photoelectric emitter 151 and receiver 152 combination wherein the emitter is positioned within slot 130 near support plane 111, while the receiver is positioned within slot 130 near the bottom surface 121 of gripper thumb 120. As another example, sensor 150 may comprise a photoelectric emitter and receiver combination in a single integrated unit such that it the unit is positioned within slot 130 either near support plane 11 or near bottom surface 121. In this case, sensor 150 may operate in a reflection mode, rather than a transmission mode. In this mode object 2 may be detected by a decrease in light received because of a difference in surface reflection properties of object 2 and gripper system 10. Alternatively, the presence of object 2 may be determined based on time-of-flight detection of light pulses emitted and received by sensor 150. In yet another example, first gripper element 100 may comprise two or more sensors 150 within slot 130 for detecting the presence of object 2. Preferably the at least two sensors are positioned at opposing side edges of slot 130—such as indicated in FIG. 3B—in order to determine proper allocation of object 2 inside slot 130. As only a rim of a plate or tray enters slot 130, the orientation of first gripper element 100 may need to be adjusted so that the back of slot 130 is substantially parallel to the tray rim for optimally securing object 2 in gripper system 10. As yet another example, the dynamic part of control signal 155 provided by sensor 150 in grasping element 100 may also be used by control system 300 to improve the engagement of the gripper elements 100,200 in gripper system 10 and/or to influence the automotive characteristics of robot 1, such as its linear or rotational velocity.

1. A gripper system for a robot, comprising:
a first gripper element configured to carry an object, the first gripper element comprises a gripper hand with a support plane configured to support the object, a gripper thumb opposing the support plane, and a slot between the gripper hand and the gripper thumb configured to allocate part of the object.

2. The gripper system of claim 1, wherein the gripper hand or gripper thumb comprises a first sensor configured to provide a first control signal.

3. The gripper system of claim 2, wherein the first sensor comprises a photoelectric emitter and receiver combination and the first control signal is indicative of the presence of the object.

4. The gripper system of claim 2, wherein the first sensor comprises a force sensor and the first control signal is indicative of a load of the object.

5. The gripper system according to claim 1, further comprising a second gripper element in cooperation with the first gripper element to secure the object between the first and second gripper elements.

6. The gripper system of claim 5, wherein the second gripper element comprises two gripper fingers spaced apart to secure the object.

7. The gripper system of claim 6, wherein the gripper fingers each comprise a fingertip comprising a second sensor configured to provide a second control signal.

8. The gripper system of claim 6, wherein the gripper thumb of the first gripper element comprises a prong for engaging between the spaced gripper fingers.

9. The gripper system of claim 5, wherein the first and second gripper elements comprise external surfaces comprising force sensors configured to detect collision with an article.

10. A robot system for supporting humans comprising the gripper system according to claim 1.

11. The robot system of claim 10, further comprising a second gripper element in cooperation with the first gripper element and a control system arranged to controllably operate a driver to engage the first gripper element with the second gripper element to secure the object between the first and second gripper elements.

12. The robot system of claim 11, wherein a control signal input of the control system is based on a first or second control signal.

13. The robot system of claim 10, wherein the robot system is an industrial robot or a service robot.
